(19) United States
(12) Patent Application Publication
(10) Pub. No.: US 2010/0290083 A1
(43) Pub. Date: Nov. 18, 2010

(54) INFORMATION PROCESSING APPARATUS, CONTROL METHOD THEREOF AND STORAGE MEDIUM

(75) Inventor: Masashi Nakagawa, Sagamihara-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/776,713

(22) Filed: May 10, 2010

(30) Foreign Application Priority Data
May 14, 2009 (JP) 2009-117372

(51) Int. Cl. G06F 3/12

(52) U.S. Cl. 358/1.15

(57) ABSTRACT

An information processing apparatus includes a specifying unit configured to specify whether to perform printing as a print control method associated with an identifier of a page according to an instruction received via a specification screen provided by a printer driver, a determination unit configured to determine a page to be printed based on an identifier of a page of document data received from an application and the print control method specified by the specifying unit, and a generation unit configured to generate print data used for printing the page determined by the determination unit.

### BACKGROUND OF THE INVENTION

1. Field of the Invention

The present invention relates to an information processing apparatus having a printing control function and a control method thereof. The present invention particularly relates to a technique for performing processing on an identifier of specific paper notified by an application according to printing behaviors registered for respective printer drivers.

2. Description of the Related Art

General procedures in which a printer prints documents or diagrams generated by an application that is executed by an information processing apparatus such as a personal computer are described below. According to a user's operation, settings related to various types of printing are performed via a user interface (UI) of a printer driver (hereafter, referred to merely as a “driver”) corresponding to a printer. These settings include, for example, paper sizes, paper orientations, page layout, print methods, color modes, stamps, and settings of stamps.

A graphic engine (denoted as “GDI”) receives document data from the application and transfers the document data to a graphic driver (denoted as “GR”). GR converts the document data into print data in a format which the printer can interpret, and the converted print data is transmitted to the printer to perform printing.

A printing system of Windows (registered trademark) includes a system in which information about paper sizes is collectively managed to freely register the information about the paper sizes to the system by settings instructed by the user, the application, and the printer driver. Further, a standard interface (I/F) for receiving/transmitting printing condition information between the application and the printer driver is provided. The I/F can transfer information about the paper sizes and methods for feeding paper using binary data of the DEVMODE structure.

Japanese Patent Application Laid-Open No. 2007-179128 discusses a technique in which the above-described system is used. In this example, the printer driver generates a desired paper size and stores the printing condition information in association with the identifier of the paper size. With this technique, a user can realize printing using the printing condition information corresponding to the paper size only by specifying the registered paper size with the paper setting of the application.

However, a print path passing through the GDI cannot convey a meaning associated with each page from the application to the printer driver.

The meaning associated with each page is an attribute included in each page of a document actually generated by the user. For example, the meaning associated with each page means, a front cover page, an appendix page, a last page, a print start page, or a print end page. Since such a meaning cannot be conveyed to the GR of the printer driver, the following issues may occur.

FIG. 1 conceptually illustrates how document data is transmitted from the application to the printer driver via the GDI. According to this example, the document includes four pages, and the meanings of respective pages are “front cover page”, “contents”, “last page”, and “appendix”. It is assumed that the user does not want to print a page having the meaning of “appendix” (appendix page) in the document data including four pages.

In such a case, as illustrated in FIG. 2, the user can set a print range via a print setting screen of the application by specifying pages. According to this example, if page 1 to page 3 are specified, the appendix page is not printed. However, the print range needs to be set on the setting screen every time the printing is performed, which can annoy the user. Further, when a new page is inserted into the middle of the document data, the range that has been specified with the pages is changed. Thus, numbers of the pages to be printed need to be specified again.

Furthermore, as illustrated in FIG. 5, when the application for creating the document data by collate printing performs multiple-up printing, a printing result that is not intended by the user may be acquired.

According to this example, when the multiple-up printing is performed by specifying three copies of the document including five pages, the last page of a printing job and the first page of a next printing job are placed and printed on a single sheet of paper. For example, a page portion (corresponding to the last page of the first copy) having a number of “5” and a page portion (corresponding to the first page of the next copy) having a number of “6” are printed on the same sheet of paper.

As with Microsoft Excel (registered trademark), the above-described case occurs when a collate setting is not notified to the printer driver. In other words, it is assumed to use only the application for repeatedly transmitting the document data for the set number of copies. In such a case, since information indicating which pages are segmentation pages is not notified to the printer driver, the above-described issue occurs.

Moreover, the technique discussed in Japanese Patent Application Laid-Open No. 2007-179128 associates a paper name with the printing condition information that can be set using the setting screen of the printer driver to store the paper name and the printing condition information. Therefore, the user does not have to set the printing condition information using the setting screen of the printer driver every time the printing is performed.

However, Japanese Patent Application Laid-Open No. 2007-179128 does not discuss that the range where the printing condition information is applied is specified. More specifically, as described above, when the user wants to remove the “appendix” from a printing target, the user has to specify page 1 to page 3 as the print range. As a result, the method discussed in Japanese Patent Application Laid-Open No. 2007-179128 cannot solve the issues described above.

### SUMMARY OF THE INVENTION

According to an aspect of the present invention, an information processing apparatus includes a specifying unit configured to specify whether to perform printing as a print control method associated with an identifier of a page according to an instruction received via a specification screen provided by a printer driver, a determination unit configured to determine a page to be printed based on an identifier of a page of document data received from an application and the print control method specified by the specifying unit, and a generation unit configured to generate print data used for printing the page determined by the determination unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of an issue to be solved by an exemplary embodiment of the present invention.

FIG. 2 illustrates an example of a user interface (UI) of a print common dialog used by a print application.

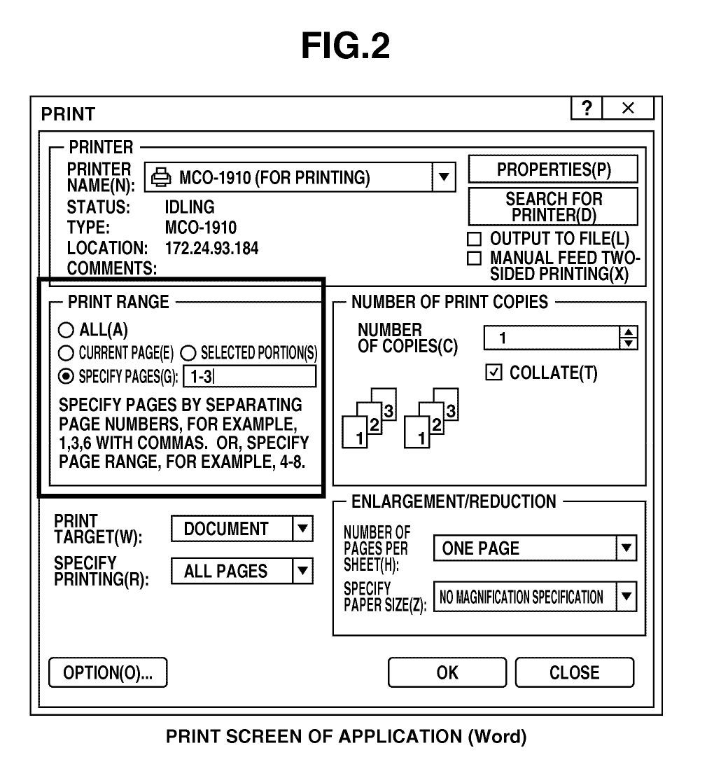

FIG. 3 illustrates processing when an appendix page is not printed.

FIG. 4 illustrates an example of the UI for page setup used by the print application.

FIG. 5 illustrates another example of the issue to be solved by the exemplary embodiment of the present invention.

FIG. 6 illustrates an example in which the issue illustrated in FIG. 5 is solved.

FIG. 7 illustrates an example of a configuration of a printing system.

FIG. 8 illustrates an example of a configuration of software.

FIG. 9 illustrates a relationship between the application and a printer driver, and a configuration of internal processing of the printer driver.

FIG. 10 illustrates an example of a screen for registering a “meaning” of paper.

FIG. 11 is a flowchart illustrating processing performed by the printer driver.

FIG. 12 illustrates an example of a screen provided with operation buttons for activating and associating a printing behavior of each printer driver with the “meaning” of the paper.

FIG. 13 illustrates an example of a setting screen for associating the printing behavior with the “meaning” of the paper.

FIG. 14 is a flowchart illustrating processing for setting the printing behavior of the printer driver to the registered “meaning” of the paper.

FIG. 15 illustrates the printing behaviors registered for respective printer drivers with respect to the registered “meaning” of the paper in the form of a list.

FIG. 16 is a flowchart illustrating an example of processing when the printing is performed.

FIG. 17 is a flowchart illustrating an example of processing when the printing is performed.

FIG. 18 is a flowchart illustrating an example of processing when the printing is performed.

### DESCRIPTION OF THE EMBODIMENTS

Various exemplary embodiments, features, and aspects of the invention will be described in detail below with reference to the drawings.

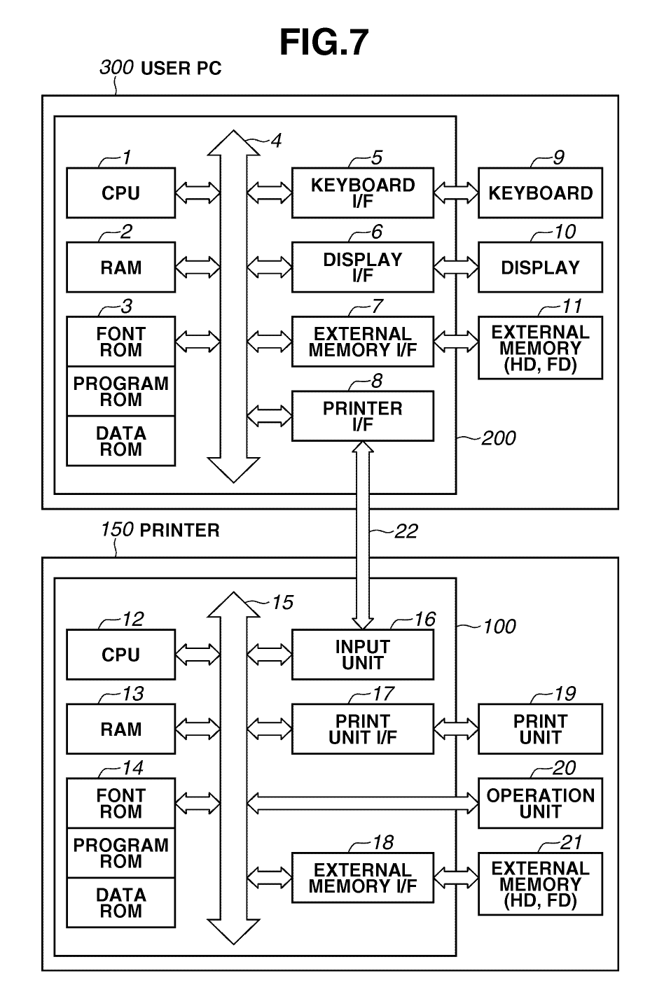

A configuration of a computer serving as an information processing apparatus according to an exemplary embodiment of the present invention will be described. FIG. 7 is a block diagram illustrating a configuration of a printer control system including the computer of the present exemplary embodiment. Not otherwise specified, as long as functions according to the present invention can be executed, the present invention can be applied to any system including a stand-alone device or a plurality of devices. Further, not otherwise specified, as long as the functions according to the present invention can be executed, the present invention can be applied to a system connected via a network such as a local area network (LAN) and a wide area network (WAN) to perform processing.

FIG. 7 illustrates a configuration of a host computer 300 and a printer 150. The host computer 300 includes a central processing unit (CPU) 1, a random access memory (RAM) 2, read only memories (ROM) 3, and various types of interfaces (hereafter, abbreviated as an “I/F”). The ROM 3 includes a font ROM, a program ROM, and a data ROM.

The CPU 1 executes processing on documents including graphics, images, characters, and tables including spreadsheet cells based on document processing programs stored in the program ROM or an external memory 11. Further, the CPU 1 comprehensively controls each device connected to a system bus 4.

The program ROM of the ROM 3 or the external memory 11 stores an operating system program (hereafter, referred to as an “OS”), which is a control program for the CPU 1. The font ROM of the ROM 3 or the external memory 11 stores font data used for processing the above-described documents. The data ROM of the ROM 3 or the external memory 11 stores various types of data used for processing the above-described documents.

The RAM 2 functions as a main memory and a working area for the CPU 1. A keyboard interface (I/F) 5 controls key input processing from a keyboard 9 and a pointing device (not illustrated). A display I/F 6 controls views on a display 10. An external memory I/F 7 controls accesses between the system and the external memory 11 such as hard disk (HD) and a flexible disk (FD). The external memory 11 stores a boot program, various types of applications, font data, user files, edition files, and a printer driver.

The printer I/F 8 is connected to a printer 150 via a predetermined bidirectional interface 22 to execute processing for controlling communication with the printer 150. The CPU 1 executes processing for rasterizing an outline font into a display information RAM set in the RAM 2 to enable “what you see is what you get” (WYSIWYG) on the display 10.

Further, the CPU 1 opens various windows registered based on a command instructed via a mouse cursor (not illustrated) on the display 10 to execute various types of data processing. When a user executes printing, the user opens windows for setting the printing and sets a method for performing print processing on the printer driver, for example, setting the printer and selecting a print mode.

The printer 150 includes a CPU 12, a RAM 13, and a ROM 14. Further, the printer 150 includes an input unit 16, an operation unit 20, a print unit I/F 17, and an external memory I/F 18. The CPU 12, the RAM 13, and the ROM 14 are communicably connected to the input unit 16, the operation unit 20, the print unit I/F 17, and the external memory I/F 18 via the system bus 15.

Based on a control program executed by the CPU 12, an image signal is output as output information to the print unit I/F (printer engine) 17 connected to the system bus 15. The control program is stored in the program ROM of the ROM 14 or an external memory 21.

The font ROM of the ROM 14 stores the font data used when the output information is generated. When the printer does not include the external memory 21 such as the hard disk (HD) and an integrated circuit (IC) card, the data ROM of the ROM 14 stores information used by the host computer 300.

The CPU 12 can perform processing for communicating with the host computer 300 via the input unit 16 to notify the host computer 300 of information about the printer 150. The RAM 13 functions as a main memory and a working area for the CPU 12, and a memory capacity of the RAM 13 can be extended with an optional RAM connected to an additional port (not illustrated). The RAM 13 is used for a region for rasterizing the output information, a region for storing environmental data, and a non-volatile (NV) RAM.

The external memory I/F 18 controls the above-described external memory 21 to access the system. The external memory 21 is provided as an option, and stores the font data, an emulation program, and the form data. A plurality of external memories 21 may be used. An optional font card in addition to built-in fonts and a plurality of external memories storing programs for interpreting a printer control language having a different language system may be connected to the system.

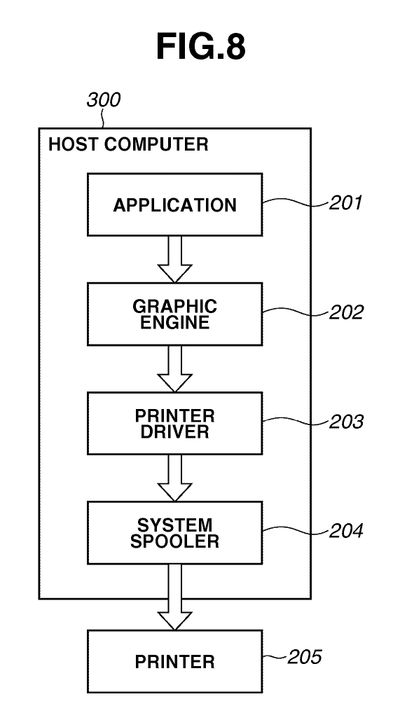

An operation unit 20 is provided with switches used for an operation on an operation panel and a light emitting diode (LED) display device. The NVRAM (not illustrated) may be disposed to store information for setting a printer mode from the operation unit 20. FIG. 8 illustrates a configuration of typical print processing performed by the host computer 300. The host computer 300 is connected to a printing apparatus, such as the printer 150, directly or via the network.

An application 201, a graphic engine 202, a printer driver 203, and a system spooler 204 exist as files stored in the external memory 11. The application 201, the graphic engine 202, the printer driver 203, and the system spooler 204 are program modules that are loaded into the RAM 2 by the OS or a module using a module of the OS when being executed by the CPU 1. The application 201 and the printer driver 203 can be added to the HD serving as the external memory 11 via the FD or a compact disc ROM (not illustrated) serving as the external memory 11, or the network (not illustrated).

The application 201 stored in the external memory 11 is loaded into the RAM 2 and executed by the CPU 1. When the application 201 performs the printing on the printer 150, the graphic engine 202 that is similarly loaded into the RAM 2 and ready for being executed is used to output data (draw images).

The graphic engine 202 similarly loads the printer driver 203 prepared for each printing apparatus into the RAM 2 from the external memory 11 and converts drawing image data output by the application 201 into printer control commands. The converted printer control commands pass through a system spooler 204 loaded into the RAM 2 by the OS, and then are output to the input unit 16 in the printer 150 illustrated in FIG. 7 via the interface 22. AS described below, the printer driver 203 generates print data to perform the print processing according to the printing behavior corresponding to the identifier of each page in the document.

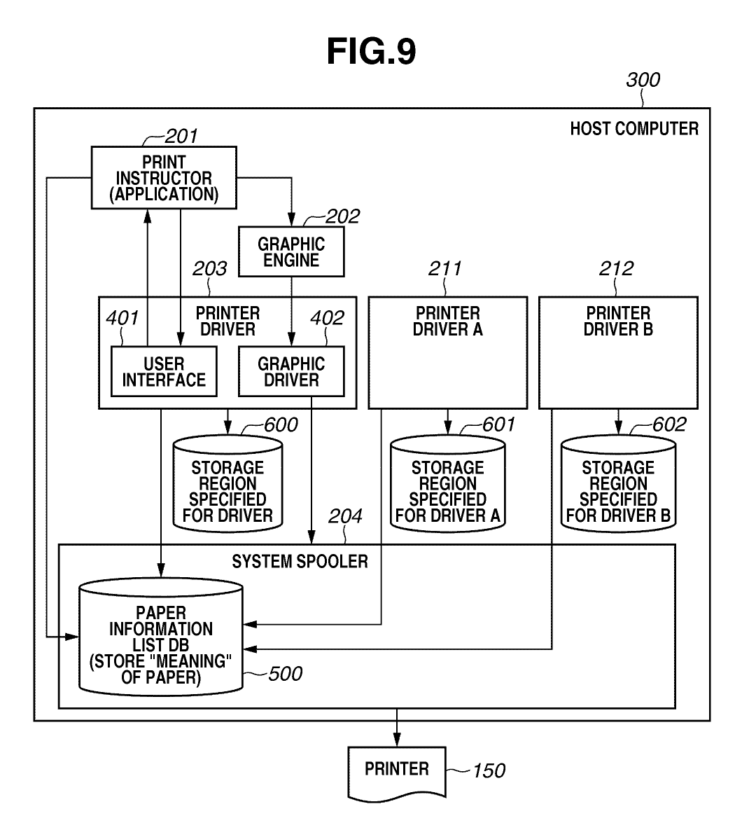

FIG. 9 illustrates a relationship between the application and the printer driver in the printing system and a configuration of internal processing performed by the printer driver according to the present exemplary embodiment. In the host computer 300, the external memory 11 stores the application 201, the graphic engine 202, the printer driver 203, and the system spooler 204. Further, in addition to the currently used printer driver 203, the external memory 11 similarly stores a printer driver “A” indicated by reference numeral 211 and a printer driver “B” indicated by reference numeral 212.

The printer driver 203 includes a UI 401 and a graphic driver 402, and a dedicated storage region 600 for each printer driver. The printer driver “A” 211 and the printer driver “B” 212 have similar configurations (not illustrated) as the printer driver 203, and are provided with dedicated storage regions 601 and 602, respectively.

The system spooler 204 retains a paper information list database (DB) 500. This paper information list DB 500 can be always used to refer to data from the printer driver 203 and the printer drivers “A” and “B”. Further, the paper information list DB 500 can be used to refer to, register, and update the data from all applications running in the host computer 300, such as the application 201, which is the print instructor. Furthermore, even if the data of the paper information is added from any printer driver, the paper information list DB 500 can be used to refer to the data from another printer driver.

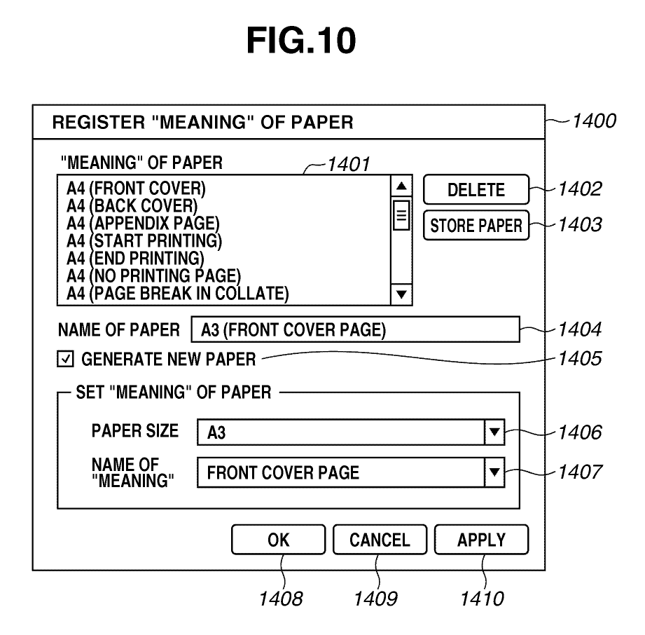

A procedure will be described for registering the paper information having a “meaning” to the paper information list DB 500 provided by the system, in the printing system according to the present exemplary embodiment. FIG. 10 illustrates an example of a screen for registering the “meaning” of the paper. The registration screen may be provided by a stand-alone application that is specified for registration, or provided by the printer driver. The application specified for registration is different from a general application, and is a program for registering information indicating the “meaning” of the paper to the paper information list DB of the system.

A registration screen 1400 is provided with a check box 1405 for newly registering the “meaning” of the paper. According to the operation instruction by the user, the check box 1405 is checked with a mark, which indicates “checked”.

Beneath the check box 1405, a setting box for the “meaning” of the paper is provided and includes a list 1406 of paper sizes and an input box 1407 for a name of the “meaning”. When the check box 1405 is operated to check the mark, the list 1406 of the paper sizes and the input box 1407 for the name of the “meaning” is enabled. More specifically, the paper size can be selected from the list 1406, and the “meaning” can be input into the input box 1407.

At a center position of the registration screen 1400, a display box 1404 for indicating a name of paper is provided. When the paper size is selected and the name of the “meaning” is input, the name of the paper having both of the paper size and the name of the “meaning” is displayed. In this example, “A3 (FRONT COVER PAGE)” is displayed based on the paper size selected from the list 1406 and the name input into the input box 1407.

At an upper portion of the registration screen 1400, a list box 1401 displaying a list of the “meaning” of the paper, a delete button 1402, and a storage button 1403 are provided at a right side of the list box 1401. When the storage button 1403 is pressed by a user's operation, the data indicating a combination of the paper set by the operation described above and the “meaning” of the paper is registered to the paper information list DB 500 and displayed on the list box 1401.

When the data of the “meaning” of the paper that is recognized to have been registered is deleted according to the user's instruction, an item to be deleted from the list box 1401 is selected. When an operation of the delete button 1402 is detected, the data of the “meaning” of the selected paper is deleted from the paper information list DB 500.

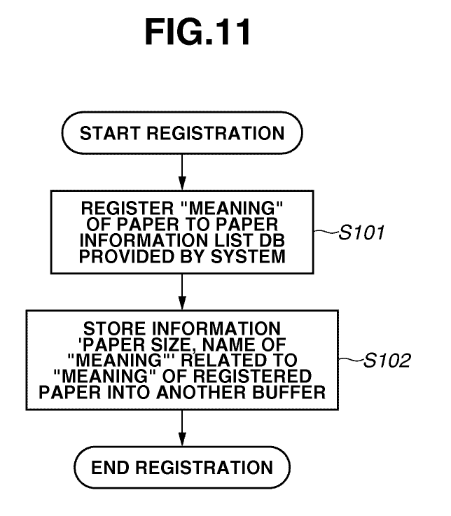

An internal operation for registering the paper will be described according to a flowchart illustrated in FIG. 11. Firstly, on the registration screen 1400, it is detected that the storage button 1403 is operated. In step S101, the printer driver or the application specified for registration registers the information of the “meaning” of the paper on the paper information list DB 500 provided by the system. Next, in step S102, the printer driver or the application specified for registration stores information (paper size and name of “meaning”) to be associated with the registered “meaning” of the paper in a predetermined buffer.

A method in which the user sets the registered “meaning” of the paper for the application 201 that is the print instructor. Generally, when printing, the application makes an inquiry about contents (paper size, resolution, and paper feeding port) that can be set for the printer driver.

In response, in addition to the list of the general paper sizes, the printer driver notifies the application of the information about the registered “meaning” of the paper. With this arrangement, even if specific processing is not performed at the side of the application, the “meaning” of the paper can be set.

A procedure will be described for registering the printing behavior of each printer driver to the registered paper information. The printing behavior of the printer driver includes an individual operation or no-operation including no-printing.

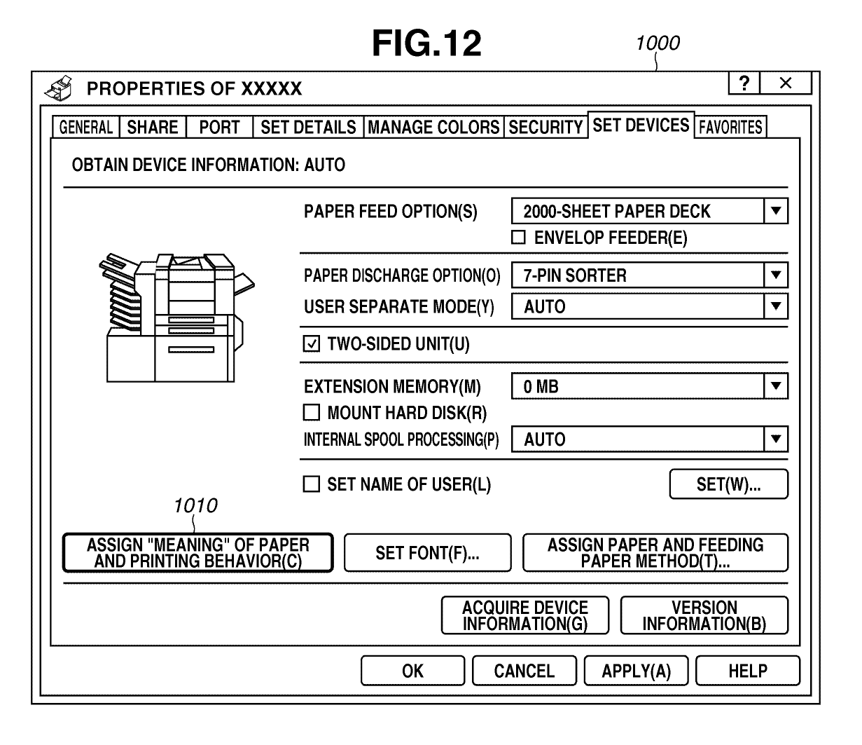

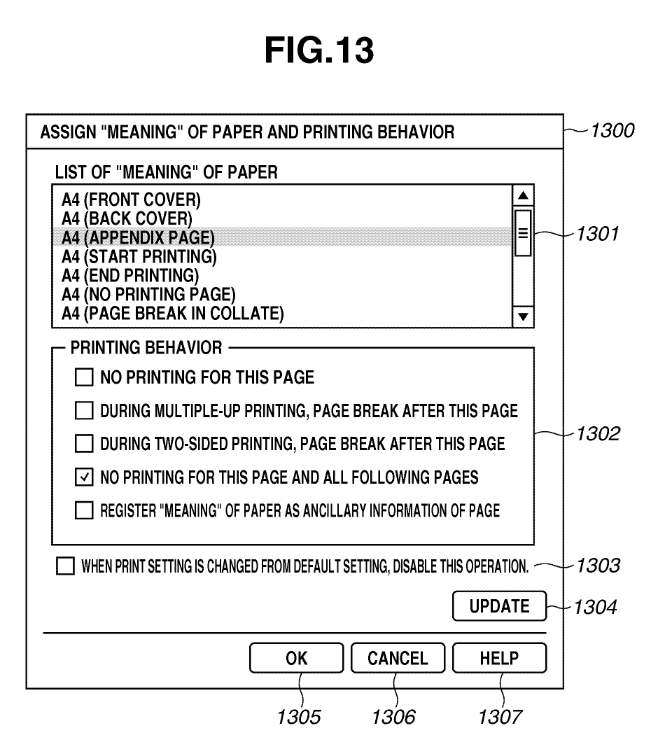

FIG. 12 illustrates an example of a property screen of the printer. At a lower portion of a property screen 1000, a button 1010 for assigning the “meaning” of the paper and the printing behavior is provided. When the user presses the button 1010, a setting screen 1300 as illustrated in FIG. 13 is displayed. By performing setting processing using the setting screen, the printing behavior can be specified without specifying page numbers.

FIG. 13 illustrates an example of the setting screen for assigning the “meaning” of the paper and the printing behavior. At an upper portion, a list 1301 displaying a list of the “meanings” of the paper is disposed. Beneath the list 1301, a selection box 1302 including a plurality of check boxes for the printing behaviors is disposed. Further, beneath the selection box 1302, as illustrated by eference numeral 1303, a check box for “WHEN PRINT SETTING IS CHANGED FROM DEFAULT SETTING, DISABLE THIS OPERATION” is disposed. An update button 1304, an OK button 1305, a cancel button 1306, and a help button 1307 are provided.

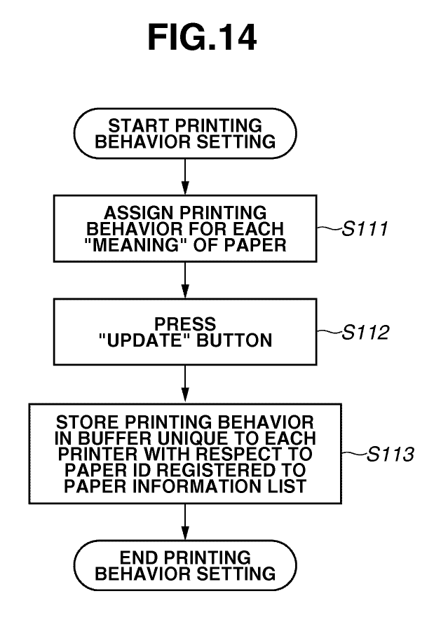

FIG. 14 is a flowchart illustrating a procedure of processing for setting the printer driver for assigning the “meaning” of the paper and the printing behavior. A flow of the processing will be described below also with reference to FIG. 13. The list 1301 for displaying the “meanings” of the paper displays the “meanings” of the paper already registered in FIG. 11. The user selects one of the items from among the “meanings” of the paper, for example, “A4 (appendix page)” is selected in FIG. 13.

A desired printing behavior can be assigned by selecting from among a group of printing behaviors in the box indicated by reference numeral 1302 for the selected item. For example, in FIG. 13, “NO PRINTING FOR THIS PAGE AND ALL FOLLOWING PAGES” is selected. As described above, in step S111, the printer driver assigns the printing behavior with respect to each paper size and each “meaning” of the paper.

After the assignment is completed according to the user's operation, when the update button 1304 is detected to be pressed, in step S112, the printer driver receives an instruction for updating the data. The printer driver receives this notification to acquire contents for setting the printing behavior for the selected paper. Subsequently, in step S113, the printer driver stores in each of dedicated storage regions 600, 601, and 602 the printing behavior of each printer driver with respect to the paper identification (ID) registered to the paper information list DB 500.

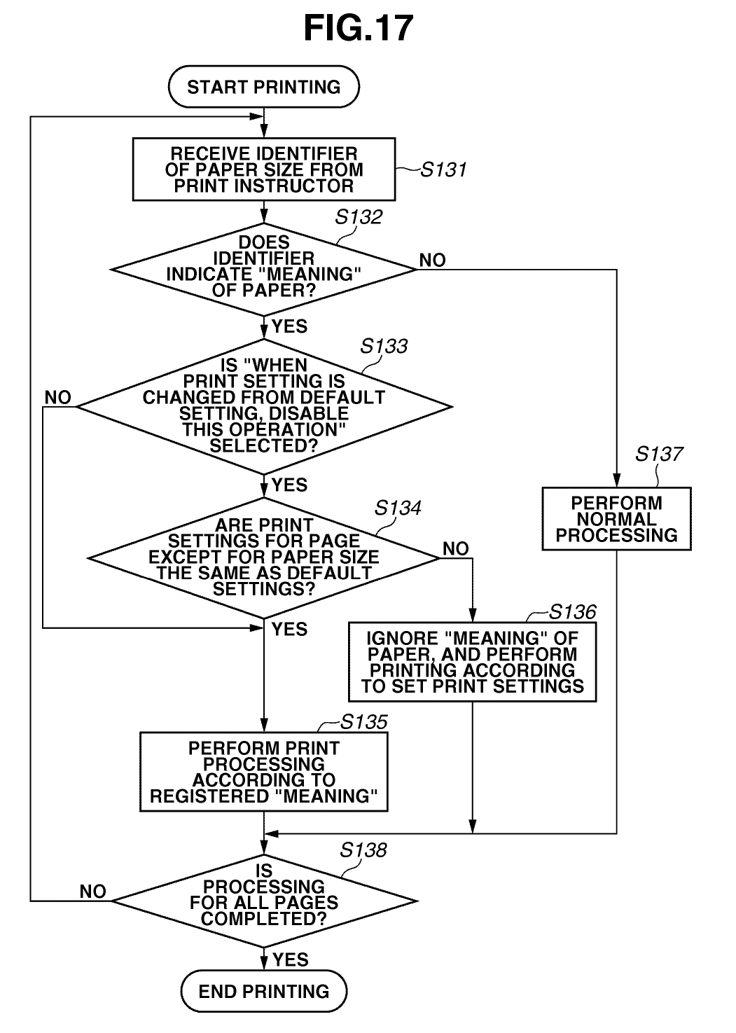

As indicated by reference numeral 1303, the setting screen illustrated in FIG. 13 is provided with a check box for enabling or disabling a function of “WHEN PRINT SETTING IS CHANGED FROM DEFAULT SETTING, DISABLE THIS OPERATION”. When this function is enabled, and when the user intentionally changes the print setting for the page on which the “meaning” of the paper is assigned, the changed print setting can be applied. The printing behavior assigned to the “meaning” is ignored. Details will be described with reference to FIG. 17.

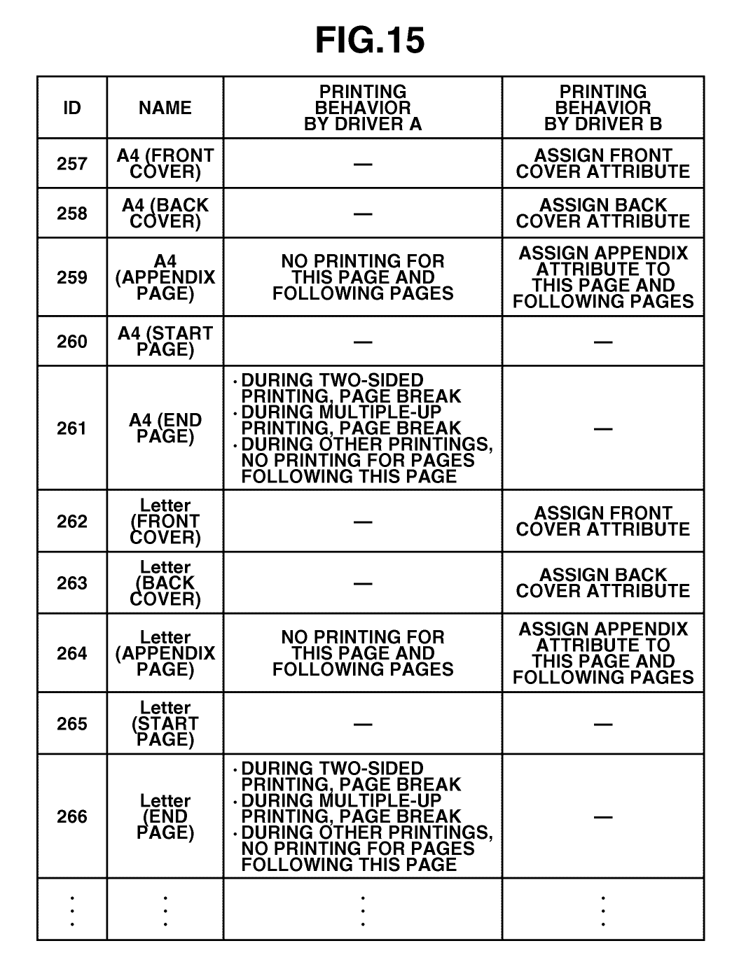

FIG. 15 illustrates an example in the form of a table when the ID numbers and names having the “meaning” of the paper to be registered to the system of Windows (registered trademark) and contents of the printer behaviors corresponding to the ID numbers and the names are registered for respective printer drivers.

The printer driver registers the data of the ID numbers (identifiers) indicated in “ID” boxes, the paper sizes indicated in “name” boxes, and the “meanings” of the paper to the paper information list DB 500 owned by the system. Data storing the printing behavior of each of printer drivers “A” and “B” is stored in each of the dedicated storage regions 601 and 602, respectively.

For example, referring to a row of an ID number 259 illustrated in FIG. 15, the name is “A4 (APPENDIX PAGE)”. The printing behavior of the printer driver “A” assigned to the ID number 259 is “NO PRINTING FOR THIS PAGE AND FOLLOWING PAGES”. The printing behavior of the printer driver “B” assigned to the ID number 259 is “ASSIGN APPENDIX ATTRIBUTE TO THIS PAGE AND FOLLOWING PAGES”. Reference symbol “-” means “not yet set”.

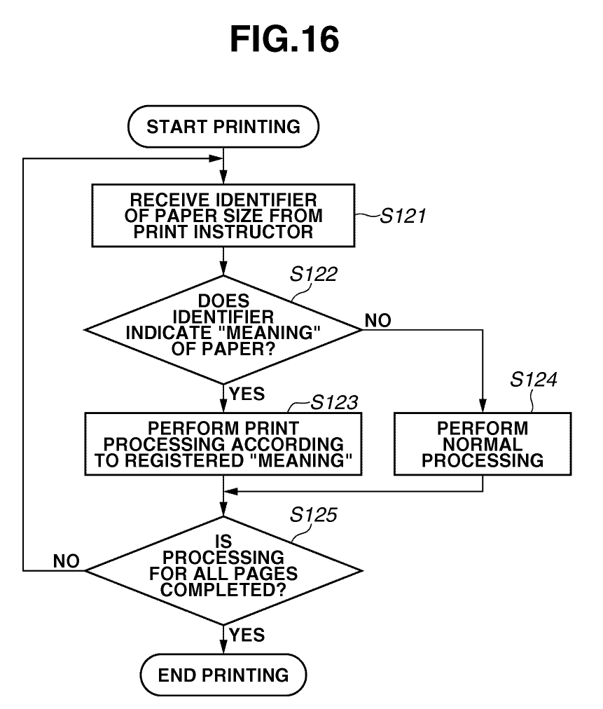

A printing behavior when a document is actually printed by the printing system of the present exemplary embodiment will be described according to a flowchart illustrated in FIG. 16. In step S121, the printer driver 203 receives document data of a page to which an identifier of the paper size is applied from the print instructor of the application.

In step S122, the printer driver 203 determines whether the received identifier of the paper size is the identifier indicating the “meaning” of the paper. Examples of determination methods will be described below.

As one method, when the registered ID number that is the identifier of the paper size has a numeral value equal to or more than a predetermined value or within a specific range of numeral values, the identifier that is the determination target is determined to be the identifier indicating the “meaning”.

As another method, the IDs of the paper sizes registered to the system is registered to the dedicated storage region 600 managed by the printer driver as a list. When an identifier matching an identifier applied to the received document data of the page exists in the list, the identifier of the determination target is determined to be the identifier indicating the “meaning”.

As a result of determining the identifier by the above-described determination method, when the identifier is the identifier indicating the “meaning” of the paper, then in step S123, the printer driver 203 generates the print data for executing the printing behavior corresponding to the identifier. For example, a case will be described in which the printer driver 203 receives the document data of the page to which the ID number 259 is applied from the application.

Referring to a row of the ID number 259 illustrated in FIG. 15, when the identifier has the meaning of the “appendix page” in A4 size, the printer driver “A” performs “NO PRINTING FOR THIS PAGE AND FOLLOWING PAGES”. Thus, when the printer driver “A” receives the document data of the page to which the ID number 259 is applied, the print data excluding the data of this page and following pages is generated.

Further, the print data may include the data of the page having the ID number 259 and following pages. In that case, the print data includes an instruction not to print the document data of the page having the ID number 259 and following pages. In any case, the printer driver “A” generates the print data without printing the page having the ID number 259 and following pages.

If it is determined that the identifier that is the determination target is not the identifier indicating the “meaning” of the paper in step S122, then in step S124, the printer driver generates the print data for performing the normal print processing as usual. The processing proceeds to step S125 after steps S123 and S124, and the printer driver 203 determines whether the processing is completed on all pages of the document data to be processed. When the processing on all pages of the document data is completed, the processing ends.

When the processing on all pages of the document data is not completed, the processing returns to step S121 to repeat the above-described processing.

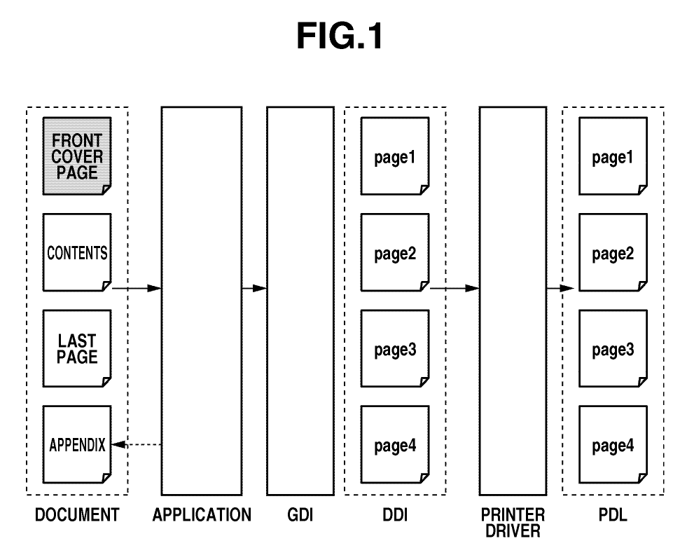

According to the first exemplary embodiment of the present invention, since the “meaning” of each paper can be conveyed from the application to the printer driver, the following issues can be solved. For example, when the user does not want to print the “APPENDIX PAGE” of the document in FIG. 1, the following procedure can be performed.

(1) Register the printing behavior of “no printing” with respect to the identifier indicating the “meaning” of the appendix page by the printer driver as illustrated in FIGS. 10 and 11.

(2) Specify by the application the “meaning (identifier)” of the appendix page to the corresponding page in the document to be printed.

When the printer driver receives the document data of the page to which the identifier of the “meaning” indicating the appendix page is applied, the printer driver performs processing on the page according to the printing behavior corresponding to the identifier. As a result, the print data not to print the appendix page is generated. Therefore, even if the user does not specify a printing range every time the printing is performed, since the printer driver does not print the appendix page, the printing processing desired by the user can be readily realized.

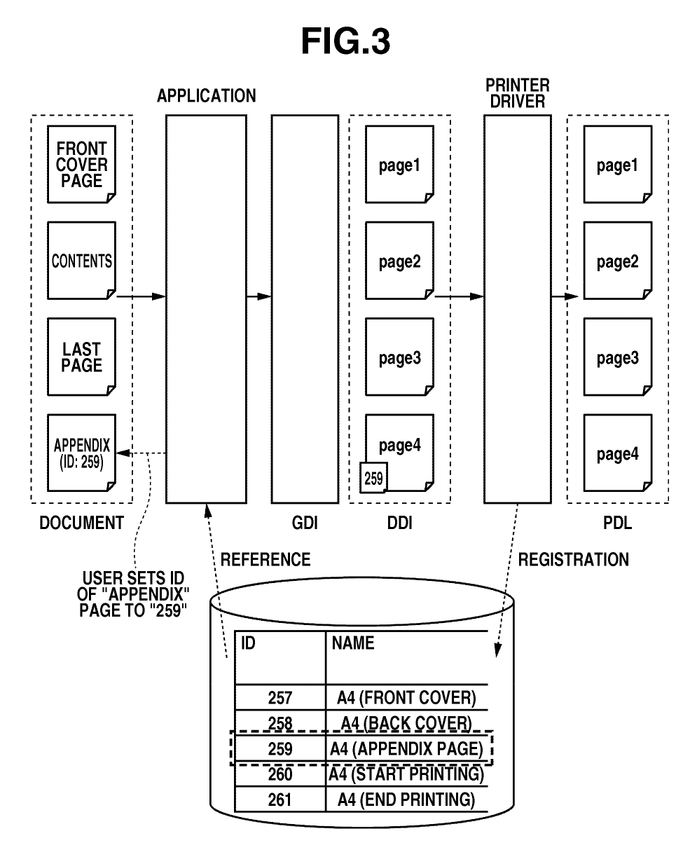

FIG. 3 illustrates a flow in which the print data is generated from the document data. The ID number 259 is applied to the appendix page of the document as a result of the user's operation. The printer driver “A” determines that the printing behavior corresponding to the appendix page is “NO PRINTING FOR THIS PAGE AND FOLLOWING PAGES” from the list illustrated in FIG. 15. Thus, the fourth page (page 4) corresponding to the appendix page is not printed. This state is illustrated with rectangular boxes drawn by dotted lines in FIG. 3.

Further, for example, even if a new page is inserted and the appendix page is changed from the fourth page to the fifth page, the printer driver determines whether to perform printing using the ID. Therefore, even if a page order of the appendix page is changed, since the printer driver does not print the appendix page, the printing processing intended by the user can be realized.

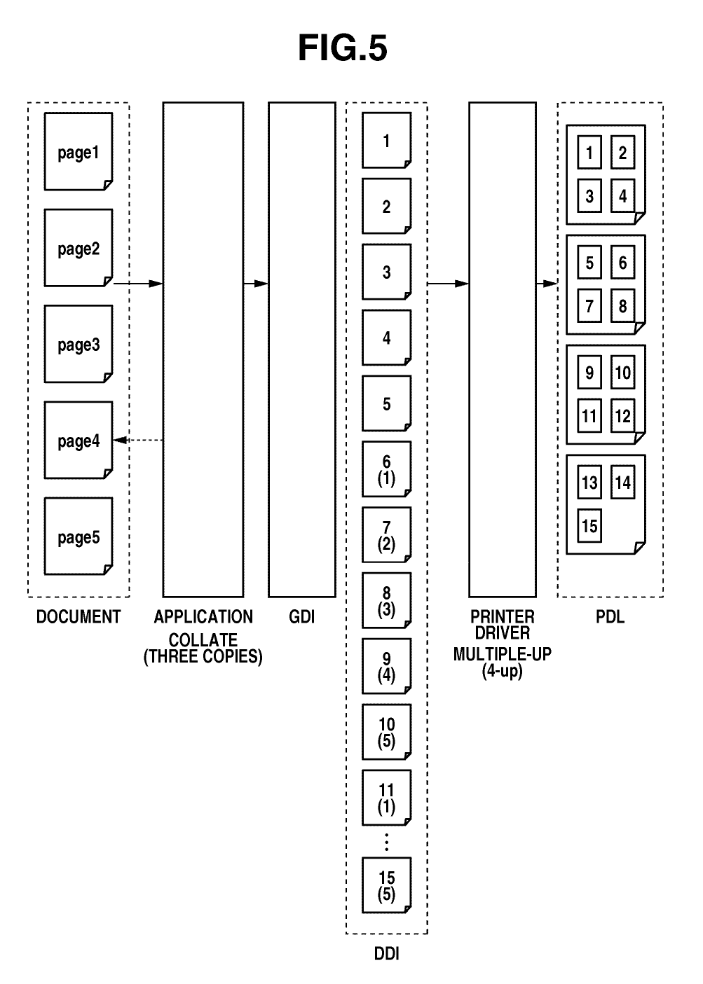

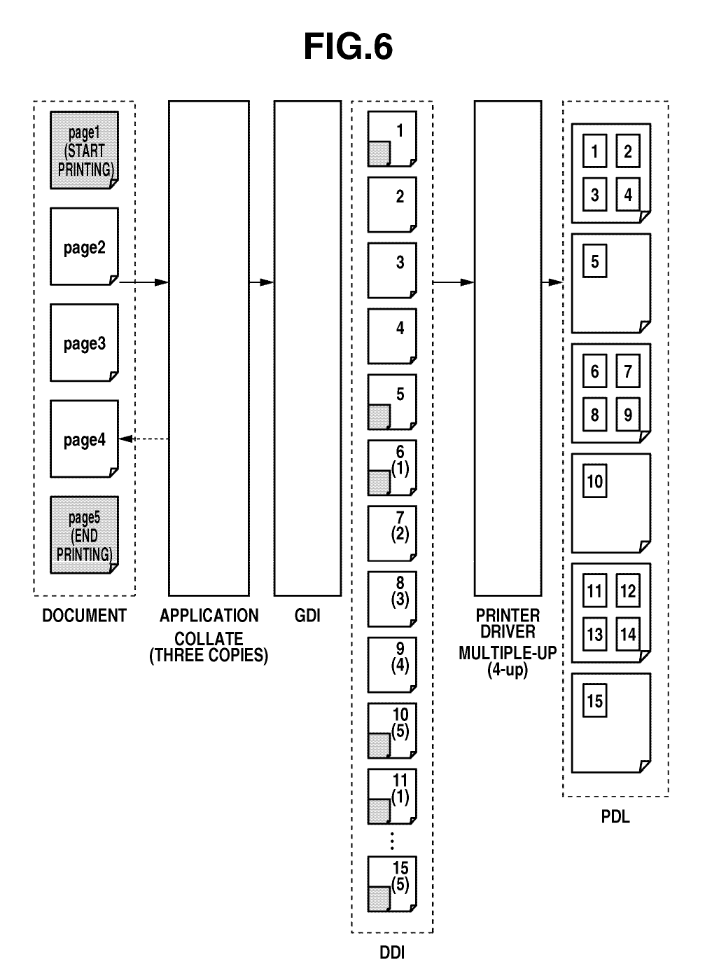

Furthermore, the printer driver registers the printing behavior for breaking a page when collate printing is performed to the identifier indicating the “meaning” of the last page. The application specifies the “meaning” of the last page to the page to be broken. With these arrangements, it can be prevented that the last page of the first copy and the first page of the second copy are disposed on a surface of the same sheet of paper as illustrated in FIG. 5. FIG. 6 illustrates a flow for generating the print data from the document data.

The first page of the document has the meaning of “start printing” and the fifth page has the meaning of “end printing”. With these meanings, after portions of the first, second, third, and fourth pages of the first copies are printed on the same sheet of paper by multiple-up printing, only the fifth page is printed on the next sheet of paper.

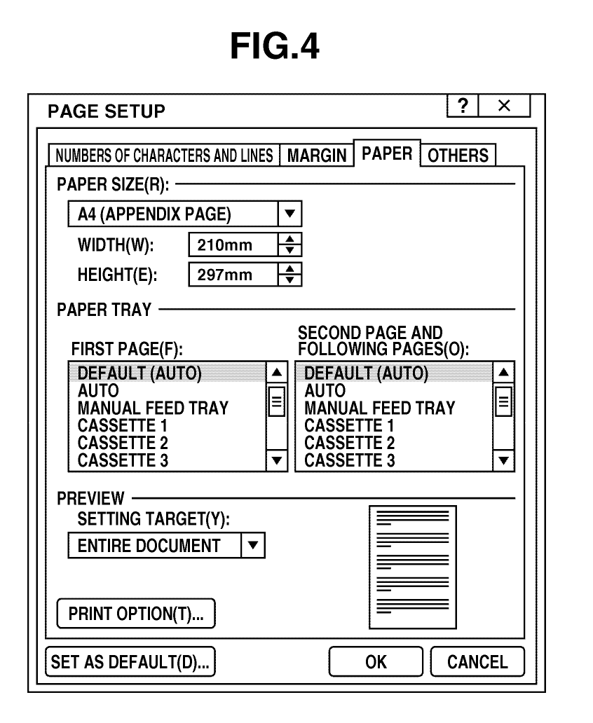

FIG. 4 illustrates a page setup screen included in the application having a general printing processing function such as Microsoft Word (registered trademark). When the present exemplary embodiment is applied, for example, an item of “A4 (APPENDIX PAGE)” is displayed on a box for “PAPER SIZE”. Thus, the user can select the desired page on an operation screen of the application, and set the paper size having the desired meaning for the page.

For example, when the user desires to apply the meaning of the appendix page in A4 size to the fourth page, the screen illustrated in FIG. 4 is opened with the fourth page selected to specify “A4 (APPENDIX PAGE)” as the paper size. As a result, the identifier indicating the appendix is applied to the fourth page as illustrated in FIG. 3.

Next, a second exemplary embodiment of the present invention will be described. In the first exemplary embodiment, the print setting set for each page is described based on that only the identifier of the paper size is used. However, some applications can set other print settings, such as a paper feed port and two-sided printing. For example, an application can specify the identifier indicating the “meaning” of the appendix page and the two-sided printing at the same time to the identifier of the paper size for a certain page.

When the printer driver receives the document data on which the above-described setting is performed, a conflict may occur between the printing behavior (no printing in the present exemplary embodiment) corresponding to the “meaning” of the appendix page and the two-sided printing specified to the appendix page. Since the printer driver cannot determine which specification of the above described specifications is to be enabled or has a priority, the printing result intended by the user may not be acquired. Thus, the second exemplary embodiment provides a solution for preventing such a conflict from occurring.

FIG. 17 is a flowchart illustrating a flow of processing. Firstly, in step S131, the printer driver 203 receives the document data of the page, to which the identifier of the paper size is applied, from the print instructor such as the application.

In step S132, the printer driver 203 determines whether the received identifier of the paper size is the identifier indicating the “meaning” of the paper. When it is determined that the identifier is not the identifier indicating the “meaning” of the paper, then in step S137, the printer driver generates the print data according to normal processing. The processing then proceeds to step S138.

When it is determined that the identifier of the determination target is the identifier indicating the “meaning” of the paper in step S132, the printer driver 203 performs determination processing in step S133. Here, as indicated by reference numeral 1303 illustrated in FIG. 13, in step S133, the printer driver 203 checks whether a check box of “WHEN PRINT SETTING IS CHANGED FROM DEFAULT SETTING, DISABLE THIS OPERATION” is checked.

When it is determined that the check box is checked (YES in step S133), the processing proceeds to step S134. When it is determined that the check box is not checked (NO in step S133), the processing proceeds to step S135.

In step S134, the printer driver 203 checks whether the print settings other than the paper size for the target page are changed from standard settings of defaults. More specifically, the printer driver performs comparison processing between default values (standard settings) of a DEVMODE structure (print settings other than paper size) received from the application and a DEVMODE structure previously stored by the corresponding printer driver 203.

For example, the printer driver 203 checks whether there are any differences in setting values of the two-sided printing, the paper feed ports, and the printing orientations. When it is determined that the print settings other than the paper size for the target page are the same as the standard settings of the defaults, the processing proceeds to step S135. On the other hand, when it is determined that the print settings other than the paper size for the target page are different from the standard settings of the defaults, the processing proceeds to step S136.

In step S135, the printer driver 203 generates the print data for executing the print processing according to the previously registered “meaning” of the paper, and the processing then proceeds to step S138. More specifically, when the print settings other than the paper size for the target page are the same as the standard settings, the printer driver generates the print data for executing the printing behavior corresponding to the meaning of the paper according to the specification indicated by reference numeral 1303 illustrated in FIG. 13.

In step S136, the printer driver 203 ignores the “meaning” of the paper and generates the print data for executing the print processing based on the setting information set by the application, and the processing then proceeds to step S138. More specifically, when the print settings other than the paper size for the target page are different from the standard settings, the printer driver ignores the printing behavior corresponding to the meaning of the paper according to the specification indicated by reference numeral 1303 illustrated in FIG. 13.

In step S138, it is determined whether the processing is completed for all pages. When the processing is completed for all pages (YES in step S138), the printing processing ends. When the processing is not completed for all pages (NO in step S138), the processing returns to step S131 to repeat the series of processing.

As described above, according to the second exemplary embodiment, which specification of the printing behavior corresponding to the “meaning” of the paper and the print setting other than the paper size has a priority can be previously determined. More specifically, a priority order is selected by the user's operation to perform the print processing according to a user's intension.

In the above-described example, a method is adopted for previously performing the settings by the user's operation before the document is printed. However, as another method, when the conflict occurs during printing, a UI screen may be displayed every time the conflict occurs.

Next, a third exemplary embodiment of the present invention will be described. The first and second exemplary embodiments are described based on that the printing behavior is registered for each printer driver with respect to the identifier indicating the “meaning” of the paper. However, it may be time consuming for the user to individually register the printing behavior for one “meaning” of the paper to all printer drivers.

For example, a case is assumed in which the identifier indicating the “meaning” of the “appendix” is registered, and the user wants each printer driver to perform processing having the same content of “no printing” with respect to the identifier. It takes long time and a management becomes complicated to register the printing behavior with respect to the identifier to each of all printers to realize the above-described content.

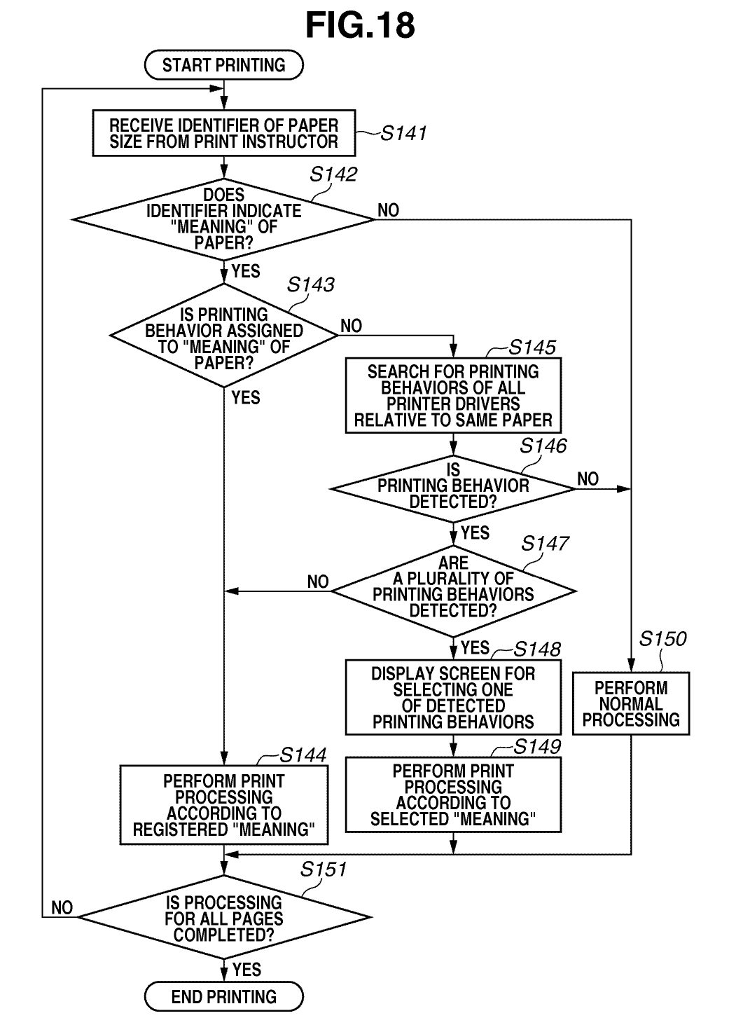

FIG. 18 is a flowchart illustrating the print processing when the printing behavior for the “meaning” is not registered by the printer driver 203 during the actual printing. For the convenience of description, in FIG. 9, the printer driver 203 is used for printing and the printing behavior for the “meaning” is not registered to the dedicated storage region 600. The printing behavior for the “meaning” is registered to the dedicated storage region 601 or 602 included in the printer driver 211 or 212, respectively.

Firstly, in step S141, the printer driver 203 receives from the print instructor such as the application the document data of the page to which the identifier of the paper size is applied. In step S142, the printer driver 203 determines whether the identifier of the paper size received from the application is the identifier indicating the “meaning” of the paper.

When it is determined that the identifier of the paper size is not the identifier indicating the “meaning” of the paper (NO in step S142), then in step S150, the normal processing is performed. The processing then proceeds to step S151.

When it is determined that the identifier of the paper size is the identifier indicating the “meaning” of the paper (YES in step S142), the processing proceeds to step S143. In step S143, the printer driver 203 determines whether the printing behavior of the printer driver 203 is registered with respect to the identifier indicating the “meaning” of the paper.

When the printer driver 203 determines that the printing behavior is already registered (YES in step S143), then in step S144, the printer driver 203 generates the print data for performing the print processing according to the registered “meaning”.

On the other hand, when the printer driver 203 determines that the printing behavior is not yet registered (NO in step S143), more specifically, when the printing behavior is registered for the same “meaning” of the paper, then in step S145, the printer driver 203 searches for all the printing behaviors in the other printer drivers 211 and 212.

After this search, in step S146, the printer driver 203 determines whether the registered printing behavior is found. When it is determined that none of the printing behaviors for the same “meaning” of the paper is registered to each of the printer drivers 211 and 212 (NO in step S146), the printer driver 203 performs the normal print processing in step S150.

In the case of the present exemplary embodiment, the printing behavior for the “meaning” is registered to the dedicated storage region 601 or 602 for the printer driver 211 or 212, respectively. Thus, since the printing behaviors of other printers are registered for the same “meaning” of the paper in step S146 (YES in step S146), then in step in S147, it is determined whether a plurality of the registered printing behaviors exist.

When it is determined that one printing behavior is registered (NO in step S147), the processing proceeds to step S144. In step S144, the printer driver 203 generates the print data for executing the printing behaviors according to the registered “meanings” for other printers.

On the other hand, when it is determined that a plurality of registered printing behaviors exist in step S147, then in step S148, the printer driver 203 displays a selection screen for selecting one printing behavior among from the plurality of the registered printing behavior. In step S149, the printer driver 203 performs the print processing according to the item selected by the user's operation. More specifically, the print processing according to the selected “meaning” is performed.

In step S151 after the processing proceeds to steps S144, 5149, and 5150, it is determined whether the processing is completed on all pages. More specifically, when the processing on all pages is completed, the print processing ends. When the processing on all pages is not completed, the processing returns to step S141 to repeat the series of processing.

As described above, according to the third exemplary embodiment, even if the printing behavior corresponding to the “meaning” of the paper is not registered to the printer driver that actually performs the printing, the information about the printing behavior registered to another printer driver can be used to perform the printing processing. In other words, if a printing behavior is already registered to another printer driver, print processing using the printing behavior can be performed by a printer driver that actually performs printing.

When a plurality of printing behaviors for one “meaning” of paper are registered to another printer driver, a method for selecting (screen display for selecting) the desired printing behavior from among the plurality of printing behaviors can be provided to the user. According to the selected printing behavior, the print processing desired by the user can be realized. According to the exemplary embodiments of the present invention, even if the user does not specify the printing range every time the printing is performed, printed products within the printing range desired by the user can be output.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-117372 filed May 14, 2009, which is hereby incorporated by reference herein in its entirety.

What is claimed is:

1. An information processing apparatus comprising:
a specifying unit configured to specify whether to perform printing as a print control method associated with an identifier of a page according to an instruction received via a specification screen provided by a printer driver;
a determination unit configured to determine a page to be printed based on an identifier of a page of document data received from an application and the print control method specified by the specifying unit; and
a generation unit configured to generate print data used for printing the page determined by the determination unit.

2. The information processing apparatus according to claim 1, further comprising:
a storage unit configured to store the print control method for respective printer drivers; and
a search unit configured to, when the print control method for a printer driver selected to perform printing is not stored in the storage unit, search for the print control method for a second printer driver,
wherein the determination unit determines a page to be printed based on the print control method searched for by the search unit.

3. The information processing apparatus according to claim 2, further comprising:
a display unit configured to, when the search unit searches for a plurality of print control methods stored for the second printer driver, display a selection screen for selecting one print control method from among the plurality of print control methods.

4. A control method executable by an information processing apparatus, the control method comprising:
specifying whether to perform printing as a print control method associated with an identifier of a page according to an instruction received via a specification screen provided by a printer driver;
determining a page to be printed based on an identifier of a page of document data received from an application and the specified print control method; and
generating print data for printing the determined page.

5. A computer-readable storage medium storing a program for causing a computer to perform a method comprising:
specifying whether to perform printing as a print control method associated with an identifier of a page according to an instruction received via a specification screen provided by a printer driver;
determining a page to be printed based on an identifier of a page of document data received from an application and the specified print control method; and
generating print data for printing the determined page.
